(19) United States
(12) Patent Application Publication
(10) Pub. No.: US 2024/0288844 A1
(43) Pub. Date: Aug. 29, 2024

(54) MACHINE TOOL CONTROL DEVICE AND MACHINE TOOL CONTROL SYSTEM

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 18/573,755

(22) PCT Filed: Jul. 29, 2021
(86) PCT No.: PCT/JP2021/028202

§ 371 Date: Dec. 22, 2023

(51) Int. Cl. G05B 19/18; B23Q 15/12

(52) U.S. Cl. CPC G05B 19/182; B23Q 15/12; G05B 2219/37087; G05B 2219/37435

(57) ABSTRACT

Provided is a machine tool control device with which it is possible to simply set control parameter ranges. This machine tool control device which controls a machine tool comprises: a control parameter-setting unit which sets control parameters; a shaft operation control unit which operates an operation shaft on the basis of the control parameters; and a trigger reception unit which receives a trigger during shaft operation by the shaft operation control unit. The control parameter-setting unit has a specifiable range-setting unit for setting specifiable ranges for the control parameters in response to the trigger reception unit having received the trigger, and sets the control parameters on the basis of the specifiable range.

### TECHNICAL FIELD

The present disclosure relates to a machine tool control device and a machine tool control system.

### BACKGROUND ART

Conventionally, machine tool control devices have been known, in which a workpiece is machined by controlling the operating shaft to move while being vibrated, such as in vibration cutting or crankpin machining. When the operating shaft is vibrated in this manner, the vibration may cause excessive shaking in the entire machine tool, which may damage the machine tool and adversely affect the machining accuracy.

Accordingly, a technique has been proposed to set an upper limit value of the control parameters such as vibration acceleration or vibration jerk, and to control the vibration below the set upper limit value, in order to prevent excessive shaking of the entire machine tool caused by the vibration of the operating shaft (see Patent Document 1, for example). It is thought that this technique can ensure a good surface finish.
Patent Document 1: Japanese Unexamined Patent Application, Publication No. 2007-044849

### DISCLOSURE OF THE INVENTION

### Problems to be Solved by the Invention

However, the upper limit value of the control parameters such as vibration acceleration or vibration jerk should be set by the designer of the machine tool considering various aspects such as the strength of the machine tool and the load due to vibration. Therefore, setting the upper limit value of the control parameters is not easy and requires a considerable amount of time and effort.

For instance, an operator may set the upper limit value of the control parameters at a provisional value and perform a test run (mock machining) of the vibration control, then set a more appropriate upper limit value of the control parameters, based on the results of the test run. However, conventionally, the test run of a machine tool and the setting of the upper limit value of the control parameters have not been coordinated as a system, which still requires a considerable amount of effort.

Therefore, a machine tool control device that can easily set a range of control parameters has been desired.

### Means for Solving the Problems

One aspect of the present disclosure is a machine tool control device that controls a machine tool, in which the device includes: a control parameter setting unit that sets control parameters; a shaft motion control unit that operates an operating shaft, based on the control parameters; and a trigger receiving unit that receives a trigger during a shaft motion operated by the shaft motion control unit, in which the control parameter setting unit includes a specifiable range setting unit that sets a specifiable range of the control parameters in response to the trigger receiving unit having received a trigger, and the control parameter setting unit sets the control parameters, based on the specifiable range.

### Effects of the Invention

According to the present disclosure, a machine tool control device that can easily set a range of control parameters can be provided.

### BRIEF DESCRIPTION OF THE DRAWINGS

FIG. 1 is a diagram illustrating a machine tool control device according to an embodiment of the present disclosure;

FIG. 2 is a diagram illustrating a display screen of a computer numerical controller when setting a vibration acceleration upper limit value in a vibration control operation, illustrating inputs of a plurality of vibration frequencies and vibration amplitudes;

FIG. 3 is a diagram illustrating a display screen of the computer numerical controller when setting the vibration acceleration upper limit value in the vibration control operation, illustrating calculation and setting of the vibration acceleration upper limit value, based on the vibration frequency and vibration amplitude;

FIG. 4 is a diagram illustrating a display screen of the computer numerical controller when setting a vibration amplitude upper limit value in the vibration control operation;

FIG. 5 is a diagram illustrating a display screen of an external computer when setting the vibration acceleration upper limit value in the vibration control operation;

FIG. 6 is a diagram illustrating a display screen of the computer numerical controller when setting the vibration acceleration upper limit value in the vibration control operation, illustrating a case where the vibration amplitude is varied for a predetermined vibration frequency;

FIG. 7 is a diagram illustrating a display screen of the computer numerical controller when setting an acceleration upper limit value in a positioning operation, illustrating inputs of a feed speed and an acceleration/deceleration time constant; and

FIG. 8 is a diagram illustrating a display screen of the computer numerical controller when setting the acceleration upper limit value in the positioning operation, illustrating the setting of the acceleration upper limit value based on the feed speed and the acceleration/deceleration time constant.

### PREFERRED MODE FOR CARRYING OUT THE INVENTION

Hereinafter, an embodiment of the present disclosure will be described in detail with reference to the drawings.

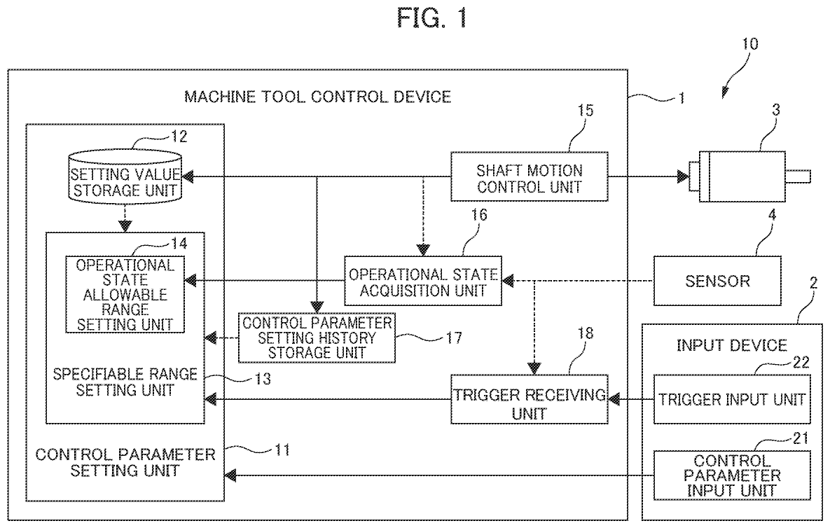

FIG. 1 is a diagram illustrating a machine tool control device 1 according to this embodiment. The machine tool control device 1 according to the present embodiment, for example, operates at least one main shaft for rotating a cutting tool (hereinafter referred to as the tool) and a workpiece relative to each other, and at least one feed shaft for moving the tool relative to the workpiece, whereby the workpiece is cut and machined by the tool. For convenience, FIG. 1 only illustrates a motor 3 that drives one feed shaft.

The machine tool control device 1 according to the present embodiment, for example, performs vibration cutting (hereinafter also referred to as oscillation cutting) by operating the main shaft and the feed shaft. That is, the machine tool control device 1, for example, performs cutting machining by rotating the tool and the workpiece relative to each other, while vibrating (hereinafter, also referred to as oscillating) the tool and the workpiece relative to each other. The tool route as a tool path is set such that the current route partially overlaps the previous route, and a portion machined in the previous route is included in the current route. Therefore, separating the tool tip from the workpiece surface (also referred to as air cutting) reliably shreds the chips which are continuously produced during the cutting machining.

The present embodiment is applicable to a configuration in which the tool vibrates while moving in the feed direction with respect to the workpiece rotating around the central axis line, and is also applicable to a configuration in which a tool T rotates around the central axis line of the workpiece, and the workpiece moves in the feed direction with respect to the tool. The present embodiment is applicable to cutting an outer diameter or an inner diameter of a workpiece. Further, the present embodiment is applicable to the case where a plurality of feed shafts (in Z-axis and X-axis) are required since the workpiece has a tapered part or an arcuate part on the machining surface, and is also applicable to the case where a specific one shaft (in Z-axis) is sufficient as a feed shaft since the workpiece is columnar or cylindrical.

The machine tool control device 1 is configured using a computer including a memory such as ROM (read only memory) or RAM (random access memory), a CPU (control processing unit), and a communication control unit, which are connected to each other via a bus. As illustrated in FIG. 1, the machine tool control device 1 includes a control parameter setting unit 11, a setting value storage unit 12, a specifiable range setting unit 13, an operational state allowable range setting unit 14, a shaft motion control unit 15, an operational state acquisition unit 16, a control parameter setting history storage unit 17, and a trigger receiving unit 18; and the functions and operations of these units can be achieved by the cooperation of the CPU, the memory, and the control program stored in the memory installed in the computer.

The machine tool control device 1 is connected to higher-level computers (not illustrated), such as a computer numerical controller (hereinafter also referred to as CNC), a PLC (programmable logic controller), or an external computer. These higher-level computers input machining programs, rotation speeds, feed speeds, and other workpiece machining conditions to the machine tool control device 1.

The workpiece machining conditions include relative rotation speeds of the workpiece and the tool around the central axis line of the workpiece, relative feed speeds of the tool and the workpiece, an acceleration/deceleration time constant, and position commands for the feed shaft, etc. In the present embodiment, the CPU inside the machine tool control device 1 may be configured to read the rotation speed and the feed speed from the inputted machining program as machining conditions, and output them to the shaft motion control unit 15; alternatively, a position command creation unit, etc. inside the shaft motion control unit 15 may be provided on the higher-level computers.

As illustrated in FIG. 1, detection signals from a sensor 4 are inputted to the machine tool control device 1. The sensor 4 includes sensors such as an encoder that detects a rotation speed, a rotation angle, and a rotation position of the motor 3, and an acceleration sensor that is provided in the machine tool and detects vibration of the entire machine tool. Detection signals from the sensor 4 are transmitted to the operational state acquisition unit 16 and the trigger receiving unit 18 (described later).

The machine tool control device 1 is connected to an input device 2. The input device 2 includes a trigger input unit 22 and a control parameter input unit 21. The input device 2 preferably includes a display unit composed of a display screen (not illustrated), and an operation unit composed of a keyboard, a touch panel, etc. (not illustrated). The operator inputs control parameters while operating the operation unit and checking the input values on the display screen.

The input device 2 may be provided in a computer numerical controller (not illustrated) or provided in an external computer or the like (not illustrated). A machine tool control system 10 according to the present embodiment is configured with the machine tool control device 1 and the input device 2. Conventionally, a test run (mock machining) of the machine tool and setting of the upper limit value of control parameters have not been coordinated as a system; however, in the present embodiment, a test run of the machine tool and the setting of the upper limit value of the control parameters are coordinated as the system, enabling efficient operation.

Here, examples of the control parameters may include vibration frequency and vibration amplitude in the vibration control operation. The vibration frequency includes a vibration frequency multiplying factor, in addition to the vibration frequency itself. The vibration amplitude includes a vibration amplitude multiplying factor, in addition to the vibration amplitude itself.

The vibration frequency multiplying factor is a vibration frequency parameter obtained by dividing the vibration frequency by the speed of the main shaft. The vibration amplitude multiplying factor is a vibration amplitude parameter obtained by dividing the vibration amplitude by half the feed amount of the feed shaft per rotation of the main shaft.

Examples of the control parameters may include a feed speed during a positioning operation (also referred to as a rapid traverse operation), and an acceleration/deceleration time constant. The control parameter setting unit 11 sets various control parameters for a vibration control operation and a positioning operation, and the set control parameters are temporarily stored in the setting value storage unit 12 (described later). The set control parameters are transmitted to the shaft motion control unit 15, the operational state acquisition unit 16, and the control parameter setting history storage unit 17 (described later).

The control parameter setting unit 11 includes a specifiable range setting unit 13 that sets a specifiable range of control parameters in response to the trigger receiving unit 18 having received a trigger. The specifiable range of control parameters is, for example, the lower and upper limit values of the vibration frequency and the vibration amplitude. In this case, the specifiable range setting unit 13 sets the lower and upper limit values of at least one of the vibration frequency or the vibration amplitude of the operating shaft, as the specifiable range of control parameters. The control parameter setting unit 11 sets the control parameters, based on the specifiable range set by the specifiable range setting unit 13. Specifically, the control parameter setting unit 11 sets the control parameters to fall within the specifiable range.

The specifiable range setting unit 13 may set the specifiable range of control parameters, based on the control parameters set by the control parameter setting unit 11 when the trigger receiving unit 18 received a trigger. The trigger receiving unit 18 receives a trigger when the problems caused by vibration exceed the tolerance level during a shaft motion such as a test run of the machine tool. Therefore, when the trigger receiving unit 18 receives a trigger, the specifiable range setting unit 13 sets the specifiable range, based on the control parameters set by the control parameter setting unit 11 and temporarily stored in the setting value storage unit 12. As a result, an appropriate specifiable range of control parameters can be easily set.

The specifiable range setting unit 13 may set a specifiable range of control parameters, based on the control parameters stored in the control parameter setting history storage unit 17. The control parameter setting history storage unit 17 stores the history of control parameters set by the control parameter setting unit 11 in the past. Therefore, the specifiable range setting unit 13 can easily set an appropriate specifiable range of control parameters based on, for example, the control parameters set in the previous or penultimate test run.

Preferably, the specifiable range setting unit 13 includes the operational state allowable range setting unit 14 that sets an operational state allowable range, in which an operation is allowed by the shaft motion control unit 15, based on the shaft motion state information acquired by the operational state acquisition unit 16. The shaft motion state information includes, for example, vibration speed, vibration acceleration, or vibration jerk. In this case, the specifiable range setting unit 13 sets a specifiable range of control parameters, based on the operational state allowable range set by the operational state allowable range setting unit 14. As a result, an even more appropriate specifiable range of control parameters can be easily set.

The operational state allowable range is defined by, for example, the lower and the upper limit values of the vibration speed, the vibration acceleration, or the vibration jerk. These parameters, such as vibration speed, vibration acceleration, or vibration jerk, are parameters attributable to the vibration of the entire machine tool. Therefore, preferably, the operational state allowable range setting unit 14 sets at least one of the vibration speed upper limit, the vibration acceleration upper limit, or the vibration jerk upper limit for the operating shaft, as the operational state allowable range.

The control parameter setting unit 11 may set the control parameters so as to continuously change. For example, the control parameter setting unit 11 may set the vibration frequency or the vibration amplitude so as to change gradually, stepwise, or continuously. As a result, for example, a shaft motion such as a test run of the machine tool is performed continuously and automatically while changing the control parameters; therefore, a range of the control parameters can be set efficiently and easily.

The control parameter setting unit 11 may change the previously set control parameters in response to the trigger receiving unit 18 having received a trigger. The trigger receiving unit 18 receives a trigger when the problems caused by vibration exceed the tolerance level during a shaft motion such as a test run of the machine tool. Therefore, in response to the trigger receiving unit 18 having received a trigger, the control parameter setting unit 11 may change the control parameters, which were set and stored in the setting value storage unit 12, in a manner that overcomes the problems caused by vibration, and may set this as a new range of the control parameters. For example, when determining that the upper limit of the vibration is reached, the control parameters such as vibration frequency and vibration amplitude, which were temporarily stored in the setting value storage unit 12, are changed to be slightly smaller values, and can be easily set as the upper limit values of the control parameters.

The setting value storage unit 12 temporarily stores the control parameters set by the control parameter setting unit 11. As described above, the control parameters temporarily stored in the setting value storage unit 12 are used when setting the specifiable range, and also used when changing the control parameters afterwards.

The control parameter setting unit 11 may acquire the control parameters from the control parameter input unit 21 of the input device 2, and set the control parameters. In this case, the control parameters inputted by the operator via the control parameter input unit 21 are set as control parameters by the control parameter setting unit 11.

The shaft motion control unit 15 operates the operating shaft, based on the control parameters. Specifically, the shaft motion control unit 15 operates the operating shaft to perform a vibration control operation or a positioning control operation, based on the control parameters. The shaft motion control unit 15 includes various functional units, such as a position command generating unit, a vibration command generating unit, a superimposed command generating unit, a learning control unit, and a position speed control unit (all of which are not illustrated), in order to perform the vibration control operation and the positioning control operation of the operating shaft.

The position command generating unit generates position commands as movement commands for the motor 3, based on the machining program and the machining conditions inputted into the machine tool control device 1. Specifically, the position command generating unit generates position commands (movement commands) for each feed shaft, based on the relative rotation speed of the workpiece and the tool around the central axis line of the workpiece, and the relative feed speed of the tool and the workpiece.

The vibration command generating unit generates vibration commands. The vibration command generating unit generates vibration commands, based on the control parameters set by the control parameter setting unit 11.

The superimposed command generating unit calculates a position deviation, which is a difference between the position command and the position feedback based on the position detection by the sensor 4 such as the encoder of the motor 3 of the feed shaft, and generates a superimposed command by superimposing the vibration command generated by the vibration command generating unit on the calculated position deviation. Alternatively, the vibration command may be superimposed on the position command, instead of the position deviation.

The learning control unit calculates the compensation amount of the superimposed command based on the superimposed command, and compensates the superimposed command by adding the calculated compensation amount to the superimposed command. The learning control unit has memory, stores the relationship between the vibration phase and the compensation amount in the memory in one or a plurality of vibration cycles, reads the superimposed command stored in the memory at a timing that allows compensation for the phase lag of the vibration operation pursuant to the responsiveness of the motor 3, and outputs the superimposed command as a compensation amount. When the vibration phase for outputting the compensation amount is not stored in the memory, a compensation amount to be outputted may be calculated from the compensation amount having a close vibration phase. In general, as the vibration frequency increases, the position deviation from the vibration command increases; therefore, by compensating with the learning control unit, the followability to the periodic vibration command can be improved.

The position speed control unit generates a torque command for the motor 3 that drives the feed shaft, based on the superimposed command to which the compensation amount is added, and controls the motor 3 with the generated torque command. As a result, machining is performed while relatively vibrating the tool T and the workpiece W.

The shaft motion control unit 15 may stop the shaft motion in response to the trigger receiving unit 18 having received a trigger. The trigger receiving unit 18 receives a trigger when the problems caused by vibration exceed the tolerance level during a shaft motion such as a test run of the machine tool. Therefore, since the shaft motion control unit 15 automatically stops the shaft motion in response to the trigger receiving unit 18 having received a trigger, occurrence of problems caused by vibration can be avoided.

The trigger receiving unit 18 receives a trigger during a shaft motion by the shaft motion control unit 15. The period during a shaft motion includes a period during an operation by the machining program, as well as during a test run of the machine tool. The trigger receiving unit 18 receives a trigger when the problems caused by vibration exceed the tolerance level during a shaft motion such as a test run of the machine tool. For example, the operator visually confirms and determines that the vibration of the entire machine tool has reached the upper limit, and the operator operates the trigger input unit 22 (described later) to input a trigger, which is received by the trigger receiving unit 18.

The trigger receiving unit 18 may receive a trigger in response to a detection signal from the sensor 4 such as an acceleration sensor provided in the machine tool. In this case, for example, when the vibration acceleration of the entire machine tool detected by the sensor 4 such as the acceleration sensor exceeds a predetermined threshold of values such as the vibration acceleration, the trigger receiving unit 18 automatically receives a trigger.

The operational state acquisition unit 16 acquires shaft motion state information. As described above, the shaft motion state information includes, for example, vibration speed, vibration acceleration, and vibration jerk of the operating shaft. The operational state acquisition unit 16, for example, acquires the shaft motion state information, based on the detection signals from the sensor 4.

The operational state acquisition unit 16 may acquire the shaft motion state information by performing a predetermined operation, based on the control parameters set by the control parameter setting unit 11. For example, the vibration acceleration is calculated using the vibration amplitude and vibration frequency by the following Formula (1).

$$[ Formula 1 ]$$

$$Vibration acceleration = α \times ( vibration amplitude ) \times {( vibration frequency )}^{2} \qquad Formula ( 1 )$$

The control parameter setting history storage unit 17 stores the setting history of the control parameters set by the control parameter setting unit 11. When the specifiable range setting unit 13 sets a specifiable range, based on the control parameters of the past, the control parameters set by the control parameter setting unit 11 in the past are acquired from the control parameter setting history storage unit 17.

The control parameter input unit 21 of the input device 2 inputs the setting values of the control parameters from the input device 2. Specifically, the control parameter input unit 21 inputs the control parameters, based on an operation by the operator via an input tool such as a keyboard or touch panel provided on the input device 2, and sends the inputted control parameters to the control parameter setting unit 11 described above.

The trigger input unit 22 of the input device 2 inputs a trigger from the input device 2. Specifically, the trigger input unit 22 inputs a trigger, based on an operation of the input tool by the operator, and sends the trigger to the trigger receiving unit 18 described above. For example, the trigger input unit 22 is configured with an upper limit setting button, an upper limit setting display section on a touch panel screen, etc.

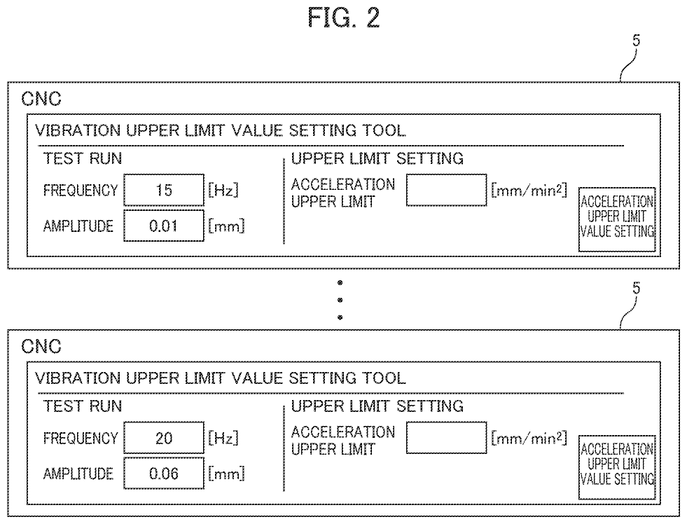

Next, the procedure for setting a range of control parameters during a vibration control operation and a positioning control operation of the operating shaft, which are performed by the machine tool control device 1, will be described in detail with reference to FIGS. 2 to 8.

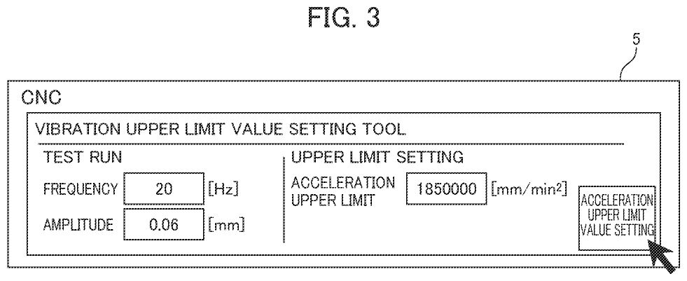

FIG. 2 is a diagram illustrating a display screen of the computer numerical controller 5 when setting the upper limit value of the vibration acceleration in the vibration control operation, illustrating inputs of a plurality of vibration frequencies and vibration amplitudes. FIG. 3 is a diagram illustrating a display screen of the computer numerical controller 5 when setting the vibration acceleration upper limit value in the vibration control operation, illustrating the calculation and setting of the vibration acceleration upper limit value, based on the vibration frequency and the vibration amplitude.

As illustrated in FIG. 2, at first, as a preliminary preparation for performing the vibration control operation, the operator inputs vibration amplitude and vibration frequency as control parameters in order to set the upper limit value of the vibration acceleration that occurs in the entire machine tool. Specifically, the operator operates the control parameter input unit 21 of the input device 2 provided on the CNC 5 to input the vibration amplitude and vibration frequency. Then, for example, the inputted values are displayed on a vibration upper limit value setting tool screen that configures the touch panel display screen of the CNC 5, and the inputted vibration amplitude and vibration frequency are set as the control parameter setting values by the control parameter setting unit 11.

Then, under the conditions of the vibration amplitude and vibration frequency thus set, a test run (mock machining) of the machine tool is performed. The vibration amplitude and vibration frequency as control parameters are inputted a plurality of times as illustrated in FIG. 2, and the test run is performed for each setting value.

As a result of the test run, when the operator determines that the vibration of the entire machine tool has reached the upper limit, and the problems caused by the vibration exceed the tolerance level, as indicated by the arrow in FIG. 3, the operator will touch the acceleration upper limit value setting displayed on the vibration upper limit value setting tool screen of the CNC 5 as the trigger input unit 22. Then, the trigger receiving unit 18 receives the trigger from the trigger input unit 22, and the vibration acceleration is calculated by Formula (1) from the vibration amplitude and the vibration frequency set during the test run. At the same time, an acceleration upper limit is displayed on the vibration upper limit value setting tool screen of the CNC 5, and is set as the vibration acceleration upper limit value. In this manner, in the present embodiment, the test run of the machine tool and the setting of a range of control parameters are coordinated as a system; therefore, for example, a vibration acceleration upper limit value can be easily set.

When the operator sets the range of control parameters by touching the acceleration upper limit value setting, the control parameters set may be changed in a manner that suppresses the problems caused by the vibration. At this time, the shaft motion control unit 15 may stop the shaft motion of the test run.

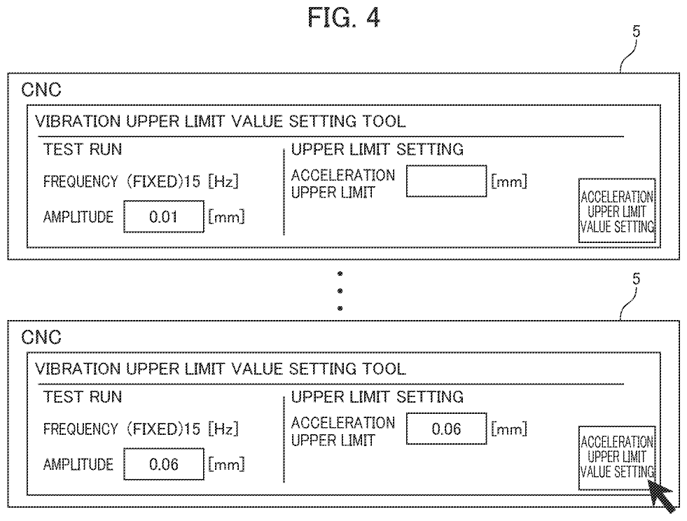

FIG. 4 is a diagram illustrating a display screen of the computer numerical controller 5 when setting the vibration amplitude upper limit value in the vibration control operation. As illustrated in FIG. 4, at first, as a preliminary preparation for performing the vibration control operation, the operator sets the upper limit value of the vibration amplitude, by changing and setting a plurality of vibration amplitudes while fixing the vibration frequency as the control parameter (which is fixed at 15 Hz in the example illustrated in FIG. 4). The procedure for inputting and setting the control parameters are as described above.

Then, under the conditions of the vibration frequency (fixed value) and the vibration amplitude (variable value) thus set, the test run (mock machining) of the machine tool is performed for each setting value. As a result of the test run, when the operator determines that the vibration of the entire machine tool has reached the upper limit, and the problems caused by the vibration exceed the tolerance level, as indicated by the arrow in FIG. 4, the operator touches the upper limit value setting displayed on the vibration upper limit value setting tool screen of the CNC 5 as the trigger input unit 22. Then, the trigger receiving unit 18 receives a trigger from the trigger input unit 22, and the vibration amplitude set during the test run is set as the vibration amplitude upper limit value. In this manner, in the present embodiment, the test run of the machine tool and the setting of a range of control parameters are coordinated as a system; therefore, for example, a vibration amplitude upper limit value can be easily set.

Note that, instead of setting the vibration amplitude upper limit value, the vibration frequency upper limit value can be set by the same procedure, and the vibration amplitude is set as a fixed value in this case. Alternatively, the same procedure can be applied to the setting of a vibration speed upper limit value and a vibration jerk upper limit value. The same procedure can be applied to the setting of not only upper limit values but also lower limit values of these control parameters. For example, the same procedure can be applied to setting a lower limit value of the control parameters in order to avoid problems such as fretting wear caused by minor vibrations of the machine tool. This also applies to the positioning control operation (described later). In this case, it is not easy for the operator to visually determine whether the problems caused by vibration exceed the tolerance level; therefore, it is better to determine based on the detection signals from the sensor 4.

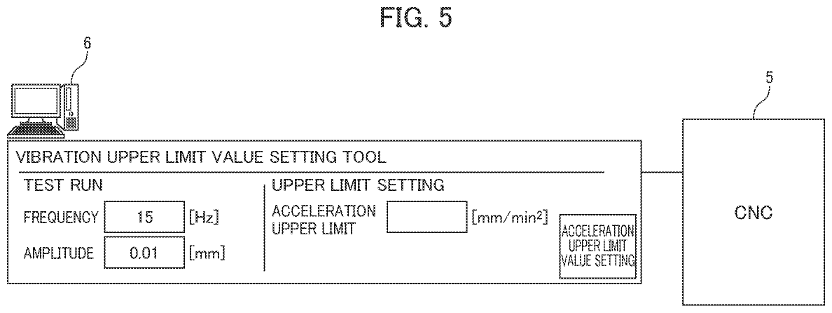

FIG. 5 is a diagram illustrating a display screen of the external computer 6 when setting the upper limit value of the vibration acceleration in the vibration control operation. FIG. 5 illustrates the case where the input device 2 is provided in the external computer 6, instead of the computer numerical controller 5. Even in such a case where the input device 2 is provided in the external computer 6, a range of control parameters can be easily set with the same procedure as described above.

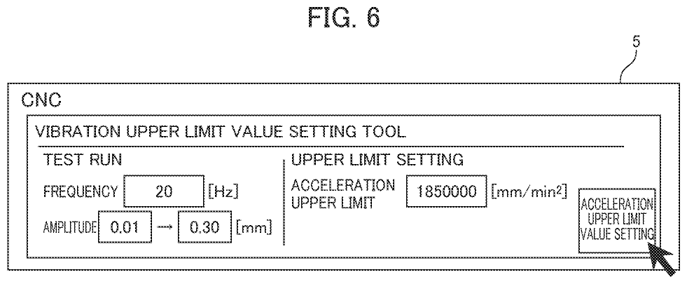

FIG. 6 is a diagram illustrating a display screen of the computer numerical controller 5 when setting the upper limit value of the vibration acceleration in the vibration control operation, illustrating the case where the vibration amplitude is changed relative to a predetermined vibration frequency. As illustrated in FIG. 6, while the vibration frequency is set as a fixed value, the vibration amplitude can be changed and set stepwise, gradually, or continuously. In this case, the test run of the machine tool is performed continuously and automatically while changing the control parameters; therefore, a range of control parameters can be more easily set. While the vibration amplitude is set as a fixed value, the vibration frequency can be changed and set stepwise, gradually, or continuously.

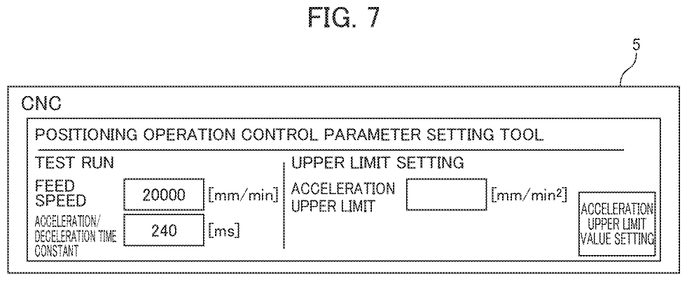

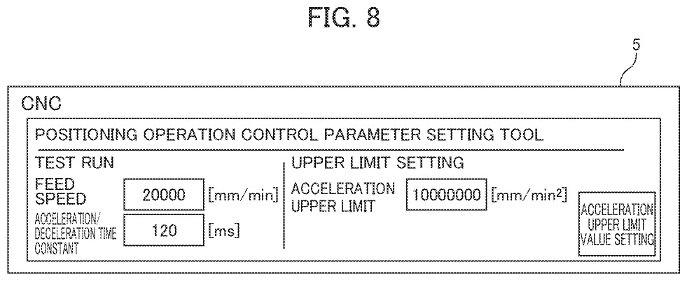

FIG. 7 is a diagram illustrating a display screen of the computer numerical controller 5 when setting the upper limit value of the acceleration in the positioning control operation, illustrating inputs of the feed speed and acceleration/deceleration time constant. FIG. 8 is a diagram illustrating a display screen of the computer numerical controller 5 when setting the upper limit value of the acceleration in the positioning control operation, illustrating the setting of the acceleration upper limit value, based on the feed speed and acceleration/deceleration time constant.

As illustrated in FIG. 7, at first, as a preliminary preparation for performing the positioning control operation, the operator inputs the feed speed and the acceleration/deceleration time constant as control parameters in order to set the acceleration upper limit value. The procedure for inputting and setting the control parameters are as described above.

Then, under the conditions of the feed speed and the acceleration/deceleration time constant thus set, the test run (mock machining) of the machine tool is performed. A plurality of feed speeds and acceleration/deceleration time constants are inputted as control parameters, and the test run is performed for each setting value.

As a result of the test run, when the operator determines that the vibration of the entire machine tool has reached the upper limit and the problems caused by the vibration exceed the tolerance level, as illustrated in FIG. 8, the operator touches the acceleration upper limit value setting displayed on the positioning operation control parameter setting tool screen of the CNC 5 as the trigger input unit 22. Then, the trigger receiving unit 18 receives a trigger from the trigger input unit 22, and the acceleration is calculated from the feed speed and the acceleration/deceleration time constant that were set during the test run. At the same time, an acceleration upper limit is displayed on the positioning operation control parameter setting tool screen of the CNC 5, and is set as the vibration acceleration upper limit value.

Note that the upper limit value of the feed speed and the upper limit value of the acceleration/deceleration time constant may be set based on the feed speed and the acceleration/deceleration time constant that were set when the operator determined that the problems caused by the vibration exceeded the tolerance level.

According to the present embodiment, the following effects are achieved.

The machine tool control device 1 according to the present embodiment includes the control parameter setting unit 11 that sets control parameters, the shaft motion control unit 15 that operates the operating shaft, based on the control parameters, and the trigger receiving unit 18 that receives a trigger while the shaft is operated by the shaft motion control unit 15. The control parameter setting unit 11 includes the specifiable range setting unit 13 that sets a specifiable range of control parameters in response to the trigger receiving unit 18 having received a trigger, and sets the control parameters, based on the specifiable range.

Conventionally, the test run of machine tools and the setting of a range of control parameters have not been coordinated as a system; therefore, when a certain motion in a test run was determined to correspond to the upper or lower limit of the vibration, the upper and lower limits of the control parameters had to be separately set after the test run ended, which was extremely laborious. However, according to the present embodiment, a specifiable range of control parameters can be easily set, based on a trigger received during the test run of the machine tool or during a shaft motion operated by the machining program. Therefore, appropriate control parameters can be easily set based on the specifiable range, while suppressing the problems caused by the vibration of the machine tool; therefore, the workload of the operator can be reduced.

The machine tool control device 1 according to the present embodiment further includes the operational state acquisition unit 16 that acquires shaft motion state information; the specifiable range setting unit 13 includes the operational state allowable range setting unit 14 that sets an operational state allowable range, in which an operation is allowed by the shaft motion control unit 15, based on the shaft motion state information acquired by the operational state acquisition unit 16; and the specifiable range setting unit 13 sets a specifiable range of the control parameters, based on the operational state allowable range. Therefore, a specifiable range of the control parameters can be easily set, based on the operational state allowable range of the control parameters set based on the shaft motion state information such as vibration acceleration; therefore, appropriate control parameters can be easily set while suppressing the problems caused by the vibration of the machine tool, based on the specifiable range.

In the present embodiment, the specifiable range setting unit 13 sets a specifiable range of at least one of vibration frequency or vibration amplitude of the operating shaft. Therefore, by setting a specifiable range of at least one of vibration frequency or vibration amplitude, appropriate control parameters such as vibration frequency and vibration amplitude can be easily set based on the specifiable range, while reliably suppressing the problems caused by the vibration of the machine tool.

In the present embodiment, the operational state allowable range setting unit 14 sets at least one of the vibration speed upper limit, the vibration acceleration upper limit, or the vibration jerk upper limit for the operating shaft, as the operational state allowable range. Therefore, by setting at least one of the vibration speed upper limit, the vibration acceleration upper limit, or the jerk upper limit for the operating shaft as the operational state allowable range, appropriate control parameters can be easily set, while more reliably suppressing the problems caused by the vibration of the machine tool.

In the present embodiment, the operational state acquisition unit 16 acquires the shaft motion state information by performing a predetermined calculation based on the control parameters set by the control parameter setting unit 11. The operational state acquisition unit 16 acquires the shaft motion state information from the detection signals of the sensor 4 provided in the machine tool.

Conventionally, for example, an operator performs a test run of a machine tool, visually checks the vibration of the entire machine tool, and when a certain motion in the test run is determined to correspond to the upper or lower limit of the vibration, the vibration acceleration at the moment is calculated from the vibration frequency and vibration amplitude, or acquired from a sensor such as an encoder, and the upper and lower limits of the vibration acceleration are set. This type of task was extremely laborious; however, according to the present embodiment, the upper and lower limits of the vibration acceleration can be acquired by the operational state acquisition unit 16; therefore, the operational state allowable range and the specifiable range of the control parameters can be easily set based on the acquired upper and lower limits of the vibration acceleration.

In the present embodiment, when the trigger receiving unit 18 receives a trigger, the specifiable range setting unit 13 sets a specifiable range of the control parameters, based on the control parameters that have been set by the control parameter setting unit 11. The specifiable range setting unit 13 sets a specifiable range of the control parameters, based on the control parameters that were stored in the control parameter setting history storage unit 17 that stores control parameters that were set by the control parameter setting unit 11 in the past.

Conventionally, for example, an operator performs a test run of a machine tool, visually checks the vibration of the entire machine tool, and when determining that a certain motion in the test run corresponds to the upper limit or lower limit of the vibration, the vibration acceleration at the moment had to be re-inputted as the upper or lower limit of the vibration acceleration. When a motion in the previous or penultimate test run was determined to correspond to the upper or lower limit of the vibration, the operator had to remember the vibration acceleration in the previous or penultimate test run, and re-input and set the vibration acceleration at the moment as the upper or lower limit of the vibration acceleration. This type of task is extremely laborious; however, according to the present embodiment, a specifiable range of the control parameters can be easily set, based on the control parameters that were set by the control parameter setting unit 11 when the trigger receiving unit 18 received a trigger, or based on the control parameters that have been stored in the control parameter setting history storage unit 17.

In the present embodiment, the control parameter setting unit 11 sets the control parameters so as to continuously change. Conventionally, when appropriate control parameters are set while suppressing the problems caused by the vibration of the machine tool, several patterns of the control parameters had to be attempted and re-set during a test run of the machine tool. This type of task is extremely laborious; however, according to the present embodiment, since the control parameters can be set so as to continuously change, a test run of the machine tool can be performed continuously and automatically while changing the control parameter; therefore, a range of the control parameters can be easily set.

In the present embodiment, the shaft motion control unit 15 stops the shaft motion in response to the trigger receiving unit 18 having received a trigger. The control parameter setting unit 11 changes the set control parameters in response to the trigger receiving unit 18 having received a trigger.

Conventionally, for example, if the problems caused by vibration exceeds the tolerance level during a test run of a machine tool, the operation is stopped or the control parameters are changed. The motion at this moment should be determined as corresponding to the upper or lower limit of the vibration; however, since the test run of the machine tool and the setting of the range of control parameters were not coordinated as a system, the range of the control parameters had to be separately set. This type of task is extremely laborious; however, according to the present embodiment, the shaft motion can be automatically stopped in response to the trigger receiving unit 18 having received a trigger. According to the present embodiment, in response to the trigger receiving unit 18 having received a trigger, the previously set control parameters can be automatically changed to other control parameters that can better overcome the problems caused by the vibration.

In the present embodiment, the trigger receiving unit 18 receives a trigger, based on the detection signals from the sensor 4 provided in the machine tool. This enables more accurate identification of the upper and lower limits of vibration, regardless of the operator's skill level, as compared to conventional methods where the operator visually checks the vibration of the entire machine tool. In particular, it is not easy for an operator to visually detect the lower limit of the vibration; however, with the present embodiment, the sensor 4 can accurately and easily detect the lower limit of the vibration. Therefore, with the present embodiment, a range of the control parameters can be more accurately and easily set.

The machine tool control system 10 according to the present embodiment includes: the machine tool control device 1; and the input device 2 that includes the control parameter input unit 21 for inputting the setting values of the control parameters, and the trigger input unit 22 for inputting a trigger. As a result, the control parameters inputted by the operator into the control parameter input unit 21 can be easily set, in response to a trigger received from the trigger input unit 22 during the test run of the machine tool or during a shaft motion operated by the machining program.

Note that the present disclosure is not limited to the above embodiments; and modifications and improvements that can achieve the objective of the present disclosure are included in the present disclosure.

For example, in the above embodiment, the present disclosure is applied to vibration cutting; however, the present disclosure is not limited to this. The present disclosure can also be applied to a machine tool control device that controls an operating shaft to move while vibrating, such as in crankpin machining, in which the same effects as in the above embodiment can be achieved.

### EXPLANATION OF REFERENCE NUMERALS

1: machine tool control device
2: input device
3: motor
4: sensor
5: computer numerical controller
6: external computer
10: machine tool control system
11: control parameter setting unit
12: setting value storage unit
13: specifiable range setting unit
14: operational state allowable range setting unit
15: shaft motion control unit
16: operational state acquisition unit
17: control parameter setting history storage unit
18: trigger receiving unit
21: control parameter input unit
22: trigger input unit

1. A machine tool control device that controls a machine tool, the device comprising:
a control parameter setting unit that sets control parameters;
a shaft motion control unit that operates an operating shaft, based on the control parameters; and
a trigger receiving unit that receives a trigger during a shaft motion operated by the shaft motion control unit,
wherein the control parameter setting unit includes a specifiable range setting unit that sets a specifiable range of the control parameters in response to the trigger receiving unit having received a trigger, and the control parameter setting unit sets the control parameters, based on the specifiable range.

2. The machine tool control device according to claim 1, further comprising:
an operational state acquisition unit that acquires shaft motion state information,
wherein the specifiable range setting unit includes an operational state allowable range setting unit that sets an operational state allowable range, in which an operation is allowed by the shaft motion control unit, based on the shaft motion state information acquired by the operational state acquisition unit, and the specifiable range setting unit sets a specifiable range of the control parameters, based on the operational state allowable range.

3. The machine tool control device according to claim 1, wherein the specifiable range setting unit sets a specifiable range of at least one of vibration frequency or vibration amplitude of the operating shaft.

4. The machine tool control device according to claim 2, wherein the operational state allowable range setting unit sets at least one of a vibration speed upper limit, a vibration acceleration upper limit, or a vibration jerk upper limit for the operating shaft, as the operational state allowable range.

5. The machine tool control device according to claim 2, wherein the operational state acquisition unit acquires the shaft motion state information by performing a predetermined calculation based on the control parameters set by the control parameter setting unit.

6. The machine tool control device according to claim 2, wherein the operational state acquisition unit acquires the shaft motion state information from a detection signal of a sensor provided in the machine tool.

7. The machine tool control device according to claim 1, wherein the specifiable range setting unit sets a specifiable range of the control parameters, based on the control parameters that were set by the control parameter setting unit when the trigger receiving unit received the trigger.

8. The machine tool control device according to claim 1, further comprising:
a control parameter setting history storage unit that stores control parameters that were set by the control parameter setting unit in the past,
wherein the specifiable range setting unit sets a specifiable range of the control parameters, based on the control parameters stored in the control parameter setting history storage unit.

9. The machine tool control device according to claim 1, wherein the control parameter setting unit sets the control parameters so as to continuously change.

10. The machine tool control device according to claim 1, wherein the shaft motion control unit stops the shaft motion in response to the trigger receiving unit having received the trigger.

11. The machine tool control device according to claim 1, wherein the control parameter setting unit changes the control parameters that have been set, in response to the trigger receiving unit having received the trigger.

12. The machine tool control device according to claim 1, wherein the trigger receiving unit receives the trigger in response to a detection signal of a sensor provided in the machine tool.

13. A machine tool control system, comprising:
the machine tool control device according to claim 1; and
an input device including a control parameter input unit that inputs setting values of the control parameters, and a trigger input unit that inputs the trigger.
